(19) United States
(12) Patent Application Publication
(10) Pub. No.: US 2007/0147803 A1
(43) Pub. Date: Jun. 28, 2007

(54) IMAGE DATA RECORDING APPARATUS, IMAGE DATA RECORDING METHOD, AND PROGRAM

(75) Inventors: Takeshi HARADA, Tokyo (JP); Yuji Saitou, Tokyo (JP); Tatsuhito Tabuchi, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/551,829

(22) Filed: Oct. 23, 2006

(30) Foreign Application Priority Data
Dec. 27, 2005 (JP) 2005-374954

(51) Int. Cl. H04N 5/91

(52) U.S. Cl. 386/131

(57) ABSTRACT

An image data recording apparatus that sets a video image aspect ratio for a recording medium according to a predetermined recording format includes a determining unit for determining whether the aspect ratio has been set for the recording medium, a selecting unit for allowing a user to select the aspect ratio to be set for the recording medium, a writing unit for writing the selected aspect ratio information in a predetermined area of the recording medium, a reading unit for reading out the aspect ratio information set for the recording medium, a setting unit for setting each unit of the image data recording apparatus according to the aspect ratio information written in the predetermined area of the recording medium or the read out aspect ratio information, and a forbidding unit for forbidding changing of the set aspect ratio.

### CROSS REFERENCES TO RELATED APPLICATIONS

The present invention contains subject matter related to Japanese Patent Application JP 2005-374954 filed in the Japanese Patent Office on Dec. 27, 2005, the entire contents of which are incorporated herein by reference.

### BACKGROUND OF THE INVENTION

1. Field of the Invention

The present invention generally relates to image data recording apparatuses, image data recording methods, and programs. In particular, the present invention relates to an image data recording apparatus, an image data recording method, and a program that record image data on a recording medium according to a format in which a video image aspect ratio settable for a single recording medium is restricted to a single kind.

2. Description of the Related Art

DVDs (Digital Versatile Discs) are widely used as recording media for storing video image data. Not only fixed video recorders but also digital video cameras employ DVDs as recording media.

There are various types of DVD, such as DVD-R (Recordable), DVD+R, DVD-RW (ReWritable), DVD+RW, and DVD-RAM (Random Access Memory). In addition, there are various types of recording format employed for recording video image data on the various types of DVD (see, for example, Japanese Unexamined Patent Application Publication No. 2002-50040).

For example, DVD+RW type discs (Hereinafter, referred to as “DVD+RW discs”) employ the DVD+RW recording format as the compatible recording format. The DVD+RW recording format is also referred to as a “DVD+VR format”, and hereinafter simply referred to as a “+VR format”.

The +VR format prescribes that only a single video image aspect ratio can be recorded in a predetermined area of a single DVD+RW disc. More specifically, information denoting the aspect ratio of “16:9” or “4:3” is recorded. That is, the +VR format forbids a plurality of sections of video image data having different aspect ratios from being recorded on a single disc.

Apparatuses that allow, when a plurality of sections of video image data (hereinafter, each section of video image data is referred to as a “chapter”) are recorded on a DVD+RW disc according to the +VR format, information denoting aspect ratios different from that set for the DVD+RW disc to be recorded as attribute information of each chapter are known. It is possible to reconstruct each chapter at the aspect ratio used at the time of recording as long as the DVD+RW disc, on which information denoting the aspect ratio is recorded by such apparatuses for each chapter, can be played back by the apparatuses. However, compatibilities of such DVD+RW discs are not guaranteed. Thus, when the DVD+RW disc is played back by playback apparatuses other than the above-mentioned apparatuses, each chapter may not be reconstructed accurately at the aspect ratio used at the time of recording.

On the other hand, DVD-RW type discs (Hereinafter, referred to as “DVD-RW discs”) employ the DVD-VIDEO format (hereinafter, referred to as the “VIDEO format”) and the DVD video recording format (hereinafter, referred to as the “−VR format”) as the compatible recording formats.

The VIDEO format and the −VR format prescribe that an aspect ratio is recorded for each chapter when a plurality of chapters are recorded on a single DVD-RW disc.

### SUMMARY OF THE INVENTION

As described above, it is desirable for image data recording apparatuses capable of selectively employing DVD+RW discs and DVD-RW discs as recording media to record image data according to the +VR format, the −VR format, or the VIDEO format according to the types of disc to be used.

More specifically, when video image data is recorded on DVD+RW discs according to the +VR format, mechanisms for setting an aspect ratio for the DVD+RW discs and for standardizing the aspect ratio of each chapter are desirable. When video image data is recorded on DVD-RW discs according to the −VR format or the VIDEO format, a mechanism for setting the aspect ratio for each chapter is desirable.

Embodiments of the present invention are made in view of such circumstances, and allow the aspect ratios of video images recorded on a predetermined recording medium to be standardized.

According to an embodiment of the present invention, an image data recording apparatus, which sets only a single video image aspect ratio for a recording medium according to a predetermined recording format, includes determining means for determining whether or not the aspect ratio has been set for the recording medium, selecting means for allowing, when the determining means determines that the aspect ratio has not been set for the recording medium, a user to select the aspect ratio to be set for the recording medium, writing means for writing information denoting the selected aspect ratio in a predetermined area, which is prescribed in the predetermined recording format, of the recording medium, reading means for reading out, when the determining means determines that the aspect ratio has been set for the recording medium, the information denoting the aspect ratio set for the recording medium, setting means for setting each unit of the image data recording apparatus according to one of the aspect ratio denoted by the information written in the predetermined area of the recording medium and the aspect ratio denoted by the read out information, and forbidding means for forbidding changing of the aspect ratio set in each unit of the image data recording apparatus.

The apparatus may further include image capturing means for capturing video images and generating corresponding image data.

The selecting means may be a graphical user interface that employs an operation screen.

The recording medium may be removable.

The recording medium may be a DVD+RW (Digital Versatile Disc+Rewritable) disc, and the predetermined recording format may be a DVD+VR (Video Recording) format.

According to another embodiment of the present invention, an image data recording method for an image data recording apparatus that sets only a single video image aspect ratio for a recording medium according to a predetermined recording format includes the steps of determining whether or not the aspect ratio has been set for the recording medium, allowing, when the aspect ratio is determined not to have been set for the recording medium, a user to select the aspect ratio to be set for the recording medium, writing information denoting the selected aspect ratio in a predetermined area, which is prescribed in the predetermined recording format, of the recording medium, reading out, when the aspect ratio is determined to have been set for the recording medium, the information denoting the aspect ratio set for the recording medium, setting each unit of the image data recording apparatus according to one of the aspect ratio denoted by the information written in the predetermined area of the recording medium and the aspect ratio denoted by the read out information, and forbidding changing of the aspect ratio set in each unit of the image data recording apparatus.

According to still another embodiment of the present invention, a program, for controlling an image data recording apparatus that sets only a single video image aspect ratio for a recording medium according to a predetermined recording format, causes computer to execute a process. The process includes the steps of determining whether or not the aspect ratio has been set for the recording medium, allowing, when the aspect ratio is determined not to have been set for the recording medium, a user to select the aspect ratio to be set for the recording medium, writing information denoting the selected aspect ratio in a predetermined area, which is prescribed in the predetermined recording format, of the recording medium, reading out, when the aspect ratio is determined to have been set for the recording medium, the information denoting the aspect ratio set for the recording medium, setting each unit of the image data recording apparatus according to one of the aspect ratio denoted by the information written in the predetermined area of the recording medium and the aspect ratio denoted by the read out information, and forbidding changing of the aspect ratio set in each unit of the image data recording apparatus.

According to another embodiment of the present invention, an image data recording apparatus, which sets only a single video image aspect ratio for a recording medium according to a predetermined recording format, includes selecting means for allowing, when the recording medium has not been initialized, a user to select the aspect ratio to be set for the recording medium, writing means for writing information denoting the selected aspect ratio in a predetermined area, which is prescribed in the predetermined recording format, of the recording medium and for initializing the recording medium, setting means for setting each unit of the image data recording apparatus according to the aspect ratio denoted by the information written in the predetermined area of the recording medium, and forbidding means for forbidding changing of the aspect ratio set in each unit of the image data recording apparatus.

According to still another embodiment of the present invention, an image data recording method for an image data recording apparatus that sets only a single video image aspect ratio for a recording medium according to a predetermined recording format includes steps of allowing, when the recording medium has not been initialized, a user to select the aspect ratio to be set for the recording medium, writing information denoting the selected aspect ratio in a predetermined area, which is prescribed in the predetermined recording format, of the recording medium and initializing the recording medium, setting each unit of the image data recording apparatus according to the aspect ratio denoted by the information written in the predetermined area of the recording medium, and forbidding changing of the aspect ratio set in each unit of the image data recording apparatus.

According to a further embodiment of the present invention, a program, for controlling an image data recording apparatus that sets only a single video image aspect ratio for a recording medium according to a predetermined recording format, causes a computer to execute a process. The process includes the steps of allowing, when the recording medium has not been initialized, a user to select the aspect ratio to be set for the recording medium, writing information denoting the selected aspect ratio in a predetermined area, which is prescribed in the predetermined recording format, of the recording medium and initializing the recording medium, setting each unit of the image data recording apparatus according to the aspect ratio denoted by the information written in the predetermined area of the recording medium, and forbidding changing of the aspect ratio set in each unit of the image data recording apparatus.

According to another embodiment of the present invention, an image data recording apparatus, which sets only a single video image aspect ratio for a recording medium according to a predetermined recording format, includes reading means for reading out information denoting the aspect ratio set for the recording medium, setting means for setting each unit of the image data recording apparatus according to the aspect ratio denoted by the read out information, and forbidding means for forbidding changing of the aspect ratio set in each unit of the image data recording apparatus.

According to still another embodiment of the present invention, an image data recording method for an image data recording apparatus that sets only a single video image aspect ratio for a recording medium according to a predetermined recording format includes the steps of reading out information denoting the aspect ratio set for the recording medium, setting each unit of the image data recording apparatus according to the aspect ratio denoted by the read out information, and forbidding changing of the aspect ratio set in each unit of the image data recording apparatus.

According to a further embodiment of the present invention, a program, for controlling an image data recording apparatus that sets only a single video image aspect ratio for a recording medium according to a predetermined recording format, causes a computer to execute a process. The process includes the steps of reading out information denoting the aspect ratio set for the recording medium, setting each unit of the image data recording apparatus according to the aspect ratio denoted by the read out information, and forbidding changing of the aspect ratio set in each unit of the image data recording apparatus.

According to at least one of the above described embodiments of the present invention, whether or not the aspect ratio has been set for the recording medium is determined. When the aspect ratio is determined not to have been set, the user is allowed to select the aspect ratio to be set for the recording medium. Information denoting the selected aspect ratio is written in a predetermined area, which is prescribed in the predetermined recording format, of the recording medium. On the other hand, when the aspect ratio is determined to have been set for the recording medium, the information denoting the set aspect ratio is read out. Then, each unit of the image data recording apparatus is set according to the aspect ratio denoted by the information written in the predetermined area of the recording medium or the aspect ratio denoted by the read out information. Changing of set aspect ratio is forbidden.

According to at least one of the above described embodiments of the present invention, when the recording medium has not been initialized, the user is allowed to select the aspect ratio to be set for the recording medium. Information denoting the selected aspect ratio is written in a predetermined area, which is prescribed in the predetermined recording format, of the recording medium, and the recording medium is initialized. Then, each unit of the image data recording apparatus is set according to the aspect ratio denoted by the information written in the predetermined area of the recording medium. Changing of set aspect ratio is forbidden.

According to at least one of the above described embodiments of the present invention, information denoting the aspect ratio set for the recording medium is read out. Then, each unit of the image data recording apparatus is set according to the aspect ratio denoted by the read out information. Changing of set aspect ratio is forbidden.

As described above, an embodiment of the present invention allows an aspect ratio of video images recorded on a predetermined recording medium to be standardized to an aspect ratio selected by a user when the aspect ratio has not been set for the recording medium or to an aspect ratio currently set when the aspect ratio has been set for the recording medium.

Another embodiment of the present invention allows an aspect ratio of video images recorded on a predetermined recording medium to be standardized to an aspect ratio selected by a user.

Still another embodiment of the present invention allows an aspect ratio of video images recorded on a predetermined recording medium to be standardized to an aspect ratio selected by a user when the aspect ratio has not been set for the recording medium or to an aspect ratio currently set when the aspect ratio has been set for the recording medium.

### BRIEF DESCRIPTION OF THE DRAWINGS

FIG. 1 is a block diagram of an example of a configuration of a digital video camera according to an embodiment of the present invention;

FIG. 2 is a flowchart illustrating an aspect ratio standardization process;

FIG. 3 is a diagram illustrating a display example of an aspect ratio setting screen;

FIG. 4 is a diagram illustrating a display example of an aspect ratio setting screen;

FIG. 5 is a flowchart illustrating a process for a formatted disc; and

FIG. 6 is a diagram illustrating a display example of a caution screen.

### DESCRIPTION OF THE PREFERRED EMBODIMENTS

Before describing embodiments of the present invention, the correspondence between the features of the present invention and the embodiments of the present invention described in the specification or the drawings is discussed below. This description is intended to assure that embodiments supporting the claimed invention are described in this specification or the drawings. Thus, even if an element in the following embodiments is not described as relating to a certain feature of the present invention, that does not necessarily mean that the element does not relate to that feature of the claims. Conversely, even if an element is described herein as relating to a certain feature of the claims, that does not necessarily mean that the element does not relate to other features of the claims.

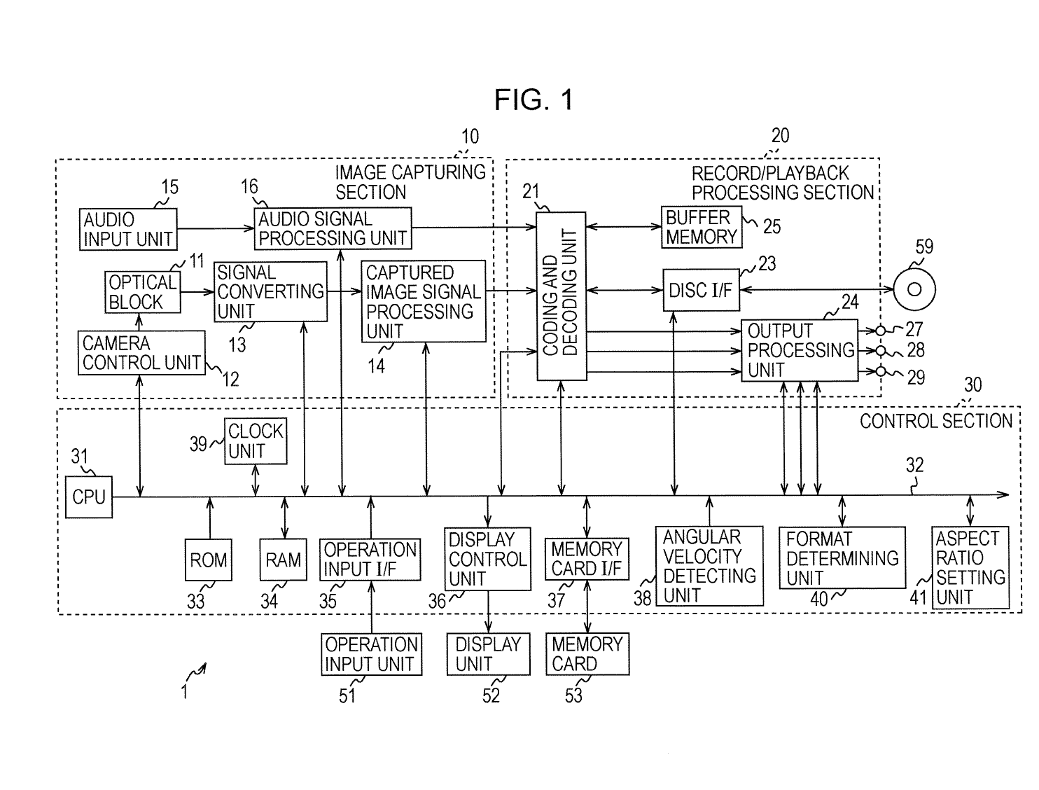

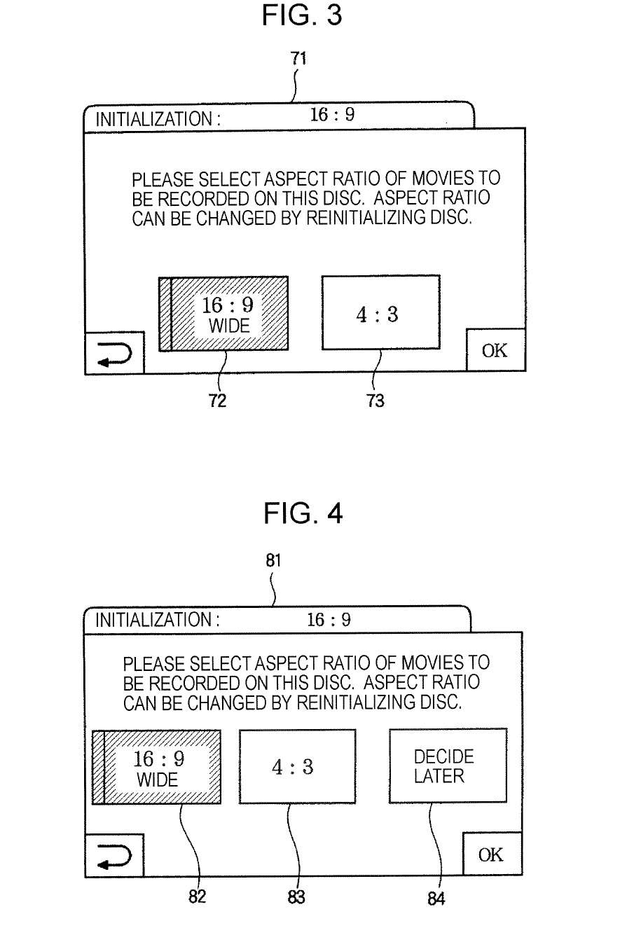

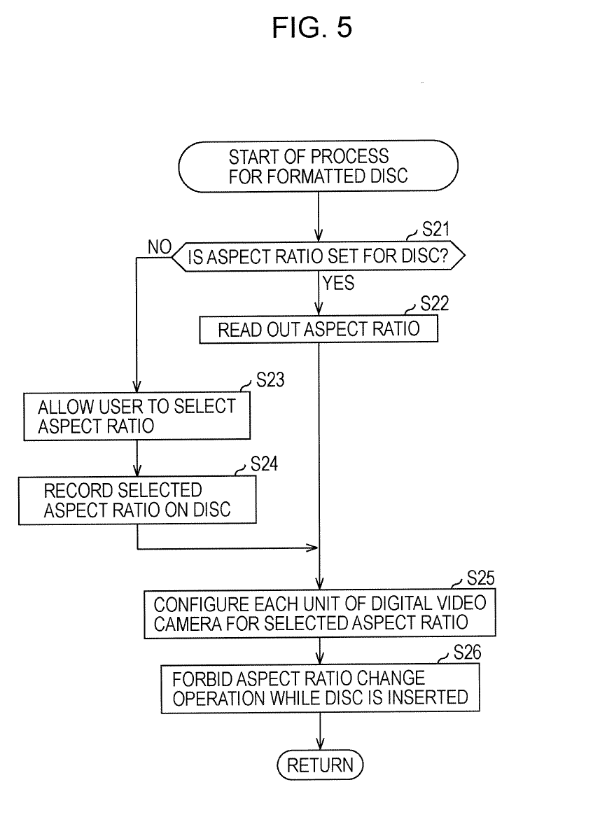

An image data recording apparatus (for example, a digital video camera 1 shown in FIG. 1) according to an embodiment of the present invention includes determining means (for example, an aspect ratio setting unit 41 shown in FIG. 1 that performs processing at STEP S21 shown in FIG. 5) for determining whether or not the aspect ratio has been set for the recording medium, selecting means (for example, an aspect ratio setting screen 71 shown in FIG. 3) for allowing, when the determining means determines that the aspect ratio has not been set for the recording medium, a user to select the aspect ratio to be set for the recording medium, writing means (for example, a disc interface 23 shown in FIG. 1 that performs processing at STEP S24 shown in FIG. 5) for writing information denoting the selected aspect ratio in a predetermined area, which is prescribed in the predetermined recording format, of the recording medium, reading means (for example, a disc interface 23 shown in FIG. 1 that performs processing at STEP S22 shown in FIG. 5) for reading out, when the determining means determines that the aspect ratio has been set for the recording medium, the information denoting the aspect ratio set for the recording medium, setting means (for example, an aspect ratio setting unit 41 shown in FIG. 1 that performs processing at STEP S25 shown in FIG. 5) for setting each unit of the image data recording apparatus according to one of the aspect ratio denoted by the information written in the predetermined area of the recording medium and the aspect ratio denoted by the read out information, and forbidding means (for example, an aspect ratio setting unit 41 shown in FIG. 1 that performs processing at STEP S26 shown in FIG. 5) for forbidding changing of the aspect ratio set in each unit of the image data recording apparatus.

The apparatus may further include image capturing means (for example, an image capturing section 10 shown in FIG. 1) for capturing video images and generating corresponding image data.

According to another embodiment of the present invention, an image data recording method and a process that a program causes a computer to execute include the steps of determining whether or not the aspect ratio has been set for the recording medium (for example, STEP S21 shown in FIG. 5), allowing, when the aspect ratio is determined not to have been set for the recording medium, a user to select the aspect ratio to be set for the recording medium (for example, STEP S23 shown in FIG. 5), writing information denoting the selected aspect ratio in a predetermined area, which is prescribed in the predetermined recording format, of the recording medium (for example, STEP S24 shown in FIG. 5), reading out, when the aspect ratio is determined to have been set for the recording medium, the information denoting the aspect ratio set for the recording medium (for example, STEP S22 shown in FIG. 5), setting each unit of the image data recording apparatus according to one of the aspect ratio denoted by the information written in the predetermined area of the recording medium and the aspect ratio denoted by the read out information (for example, STEP S25 shown in FIG. 5), and forbidding changing of the aspect ratio set in each unit of the image data recording apparatus (for example, STEP S26 shown in FIG. 5).

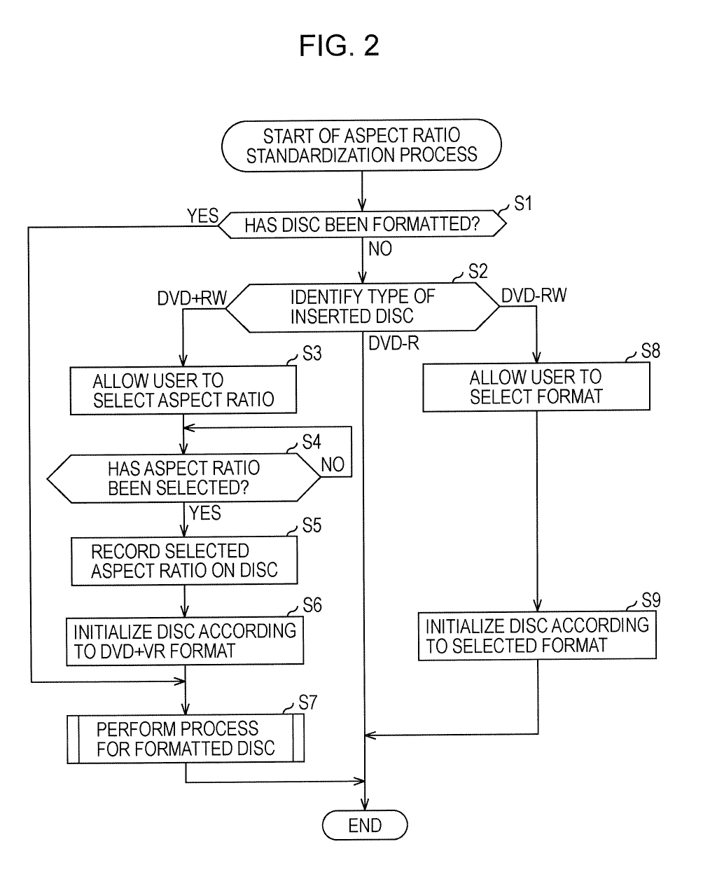

According to still another embodiment of the present invention, an image data recording apparatus (for example, a digital video camera 1 shown in FIG. 1) includes selecting means (for example, an aspect ratio setting screen 71 shown in FIG. 3) for allowing, when the recording medium has not been initialized, a user to select the aspect ratio to be set for the recording medium, writing means (for example, a disc interface 23 shown in FIG. 1 that performs processing at STEP S5 shown in FIG. 2) for writing information denoting the selected aspect ratio in a predetermined area, which is prescribed in the predetermined recording format, of the recording medium and for initializing the recording medium, setting means (for example, an aspect ratio setting unit 41 shown in FIG. 1 that performs processing at STEP S25 shown in FIG. 5) for setting each unit of the image data recording apparatus according to the aspect ratio denoted by the information written in the predetermined area of the recording medium, and forbidding means (for example, an aspect ratio setting unit 41 shown in FIG. 1 that performs processing at STEP S26 shown in FIG. 5) for forbidding changing of the aspect ratio set in each unit of the image data recording apparatus.

According to a further embodiment of the present invention, an image data recording method and a process that a program causes a computer to execute include the steps of allowing, when the recording medium has not been initialized, a user to select the aspect ratio to be set for the recording medium (for example, STEP S3 shown in FIG. 2), writing information denoting the selected aspect ratio in a predetermined area, which is prescribed in the predetermined recording format, of the recording medium (for example, STEP S5 shown in FIG. 2) and initializing the recording medium (for example, STEP S6 shown in FIG. 2), setting each unit of the image data recording apparatus according to the aspect ratio denoted by the information written in the predetermined area of the recording medium (for example, STEP S25 shown in FIG. 5), and forbidding changing of the aspect ratio set in each unit of the image data recording apparatus (for example, STEP S26 shown in FIG. 5).

According to another embodiment of the present invention, an image data recording apparatus (for example, a digital video camera 1 shown in FIG. 1) includes reading means (for example, a disc interface 23 shown in FIG. 1 that performs processing at STEP S22 shown in FIG. 5) for reading out information denoting the aspect ratio set for the recording medium, setting means (for example, an aspect ratio setting unit 41 shown in FIG. 1 that performs processing at STEP S25 shown in FIG. 5) for setting each unit of the image data recording apparatus according to the aspect ratio denoted by the read out information, and forbidding means (for example, an aspect ratio setting unit 41 shown in FIG. 1 that performs processing at STEP S26 shown in FIG. 5) for forbidding changing of the aspect ratio set in each unit of the image data recording apparatus.

According to still another embodiment of the present invention, an image data recording method and a process that a program causes a computer to execute include the steps of reading out information denoting the aspect ratio set for the recording medium (for example, STEP S22 shown in FIG. 5), setting each unit of the image data recording apparatus according to the aspect ratio denoted by the read out information (for example, STEP S25 shown in FIG. 5), and forbidding changing of the aspect ratio set in each unit of the image data recording apparatus (for example, STEP S26 shown in FIG. 5).

Embodiments of the present invention will be described in detail below with reference to the accompanying drawings.

FIG. 1 illustrates an example of a configuration of a digital video camera according to an embodiment of the present invention. A digital video camera 1 captures video images and still images and records the resulting image data on a recording medium, e.g., a disc 59.

The digital video camera 1 generally includes an image capturing section 10, a record/playback processing section 20, and a control section 30. The image capturing section 10 captures images of a subject and obtains audio signals corresponding to image signals. The record/playback processing section 20 encodes the image and audio signals and records the encoded image and audio signals on the disc 59. The record/playback processing section 20 also reads out and plays back the recorded image and audio signals. The control section 30 controls the image capturing section 10 and the record/playback processing section 20.

The image capturing section 10 includes an optical block 11, a camera control unit 12, a signal converting unit 13, a captured image signal processing unit 14, an audio input unit 15, and an audio signal processing unit 16. The optical block 11 has a lens unit for capturing an image of a subject, an aperture control mechanism, a focus adjustment mechanism, a zooming mechanism, a shutter mechanism, a flash mechanism, and a camera shake correction mechanism. The camera control unit 12 generates control signals for performing control operations on the optical block 11 according to control signals supplied from the control section 30. The control operations include a zooming control operation, a shutter control operation, and an exposure control operation. The camera control unit 12 outputs the generated control signals to the optical block 11.

The signal converting unit 13 includes an imaging device, such as, for example, a CCD (Charge Coupled Device) or a CMOS (Complementary Metal Oxide Semiconductor). An optical image of a subject is formed on an image plane of the imaging device through the optical block 11. The signal converting unit 13 converts the optical image of the subject formed on the image plane into an electric captured image signal according to an image capturing timing signal. The signal converting unit 13 then outputs the captured image signal to the captured image signal processing unit 14. The image capturing timing signal is supplied from the control section 30 in response to an operation of the shutter.

The captured image signal processing unit 14 performs operations, such as gamma correction and AGC (Auto Gain Control) on the captured image signals according to the control signals supplied from the control section 30. The captured image signal processing unit 14 also digitalizes the captured analog image signals. The audio input unit 15 collects audio data relating to sound around the subject while shooting movies, converts the collected audio data into audio signals, and outputs the audio signals to the audio signal processing unit 16. The audio signal processing unit 16 performs operations, such as correction and AGC, on the audio signals according to the control signals supplied from the control section 30. The audio signal processing unit 16 also digitalizes the analog audio signals.

The record/playback processing unit 20 includes a codec (encoder/decoder) 21, a disc interface (I/F) 23, an output processing unit 24, and a buffer memory 25.

The codec 21 performs control operations on the image signals fed from the captured image signal processing unit 14 according to the control signals supplied from the control unit 30. The control operations include a white balance control operation, an exposure compensation control operation, and a zooming control operation corresponding to a digital zoom ratio. The codec 21 also encodes the image and audio signals fed from the image capturing section 10 according to a predetermined format (e.g., an MPEG (Moving Picture Experts Group) 2 format), and outputs the resulting encoded data to the disc interface 23. In addition, the codec 21 decodes the encoded data read out from the disc 59 by the disc interface 23, and supplies the resulting image and audio signals to the output processing unit 24.

The disc interface 23 records the encoded data fed from the codec 21 on the disc 59 under the control of the control section 30. The disc interface 23 also reads out the encoded data from the disc 59 and supplies the data to the codec 21. The output processing unit 24 supplies the compressed data supplied from the codec 21 to the control section 30 and output terminals 27 to 29 under the control of the control section 30. The buffer memory 25 includes, for example, an SDRAM (Synchronous Dynamic Random Access Memory) or the like. The buffer memory 25 is utilized as a work area for the encoding and decoding performed by the codec 21. The buffer memory 25 is also utilized as a standby area for buffering the encoded data encoded by the codec 21 before the encoded data is fed to the disc interface 23.

The control section 30 includes a CPU (Central Processing unit) 31, a ROM (Read Only Memory) 33, a RAM (Random Access Memory) 34, an operation input interface 35, a display control unit 36, a memory card interface 37, an angular velocity detecting unit 38, a clock unit 39, a format determining unit 40, and an aspect ratio setting unit 41, all of which are connected to each other via a system bus 32. The operation input interface 35 transfers operation signals fed from an operation input unit 51 to the CPU 31. The display control unit 36 allows connection of a display unit 52. The memory card interface 37 allows a memory card 53 to be inserted therein. The angular velocity detecting unit 38 detects an angular velocity used for the camera shake correction. The clock unit 39 allows a time of the shooting operation to be obtained. The format determining unit 40 determines a format of the disc 59. The aspect ratio setting unit 41 sets an aspect ratio of images.

The CPU 31 controls the entire system of the digital video camera 1 by executing control programs recorded on the ROM 33. The CPU 31 uses the PAM 34 as the work area thereof. Programs for controlling the image capturing section 10 and programs for controlling the recording and playback of the image and audio signals are prestored in the ROM 33.

The memory card interface 37 writes the compressed data supplied from the codec 21 in the memory card 53. The memory card interface 37 also reads out the compressed data from the memory card 53, and supplies the data to the codec 21. The clock unit 39 generates timestamp information representing year, month, date, hour, minute, and second.

The angular velocity detecting unit 38 includes a gyroscope that detects the angular velocity externally applied to the digital video camera 1. The CPU 31 is notified of the angular velocity information [ω=(θ/second)] detected by the gyroscope at a predetermined time interval, and this information is utilized for controlling the camera shake correction mechanism in the optical block 11.

The format determining unit 40 determines whether or not the disc 59 inserted in the disc interface 23 is formatted. The format determining unit 40 also determines the type of formatting to be performed on the basis of a user's selection when the disc 59 is not formatted. The aspect ratio setting unit 41 sets the aspect ratio of the video images and still images on the basis of the user's selection or information having been recorded on the disc 59.

The operation input unit 51 has a plurality of keys such as a mode switching key, a zoom adjusting key, an exposure adjustment key, a shutter key for shooting still images, a recording key for shooting movies, a display adjusting key for the display unit 52, and keys for moving and setting a cursor on a screen of the display unit 52. The mode switching key allows switching between modes, such as a shooting mode and a playback mode. In response to the user's operations on the keys, the operation input unit 51 outputs the operation signals to the operation input interface 35. The operation signals are transferred to the CPU 31 via the operation input interface 35. The CPU 31 identifies the keys operated in the operation input unit 51 on the basis of the operation signals, and performs the control operations according to the identification result.

The display unit 52 includes, for example, an LCD (Liquid Crystal Display) or the like. The display unit 52 displays the images corresponding to the image signals (i.e., through images) fed from the captured image signal processing unit 14 of the image capturing section 10 and the image signals (i.e., playback images) read out from the disc 59 on the basis of the control signals fed from the CPU 31 via the display control unit 36. The through images and the playback images are displayed with icons showing a status of the digital video camera 1 (e.g., an amount of remaining battery and a currently set aspect ratio) being superimposed on the images. Additionally, the display unit 52 displays operation screens that allow users to select, for example, the format, the aspect ratio, and the recording mode.

The disc 59 is a recording medium removable from the disc interface 23. Types of the disc 59 include a DVD-R (Digital Versatile Disc-Recordable) disc, a DVD-RW (Digital Versatile Disc-ReWritable) disc, and a DVD+RW disc. The digital video camera 1 initializes a DVD+RW disc according to a “+VR (Video Recording) format”. The digital video camera 1 initializes a DVD-RW disc according to a “−VR format” or a “VIDEO format”. A DVD-R disc is free from such an initialization operation.

An operation performed by the digital video camera 1 will be described next.

FIG. 2 is a flowchart illustrating an aspect ratio standardization process performed by the digital video camera 1. The aspect ratio standardization process is started as soon as the disc interface 23 recognizes insertion of the disc 59.

At STEP S1, the format determining unit 40 determines whether or not the inserted disc 59 has been formatted. If the format determining unit 40 determines that the disc 59 is not formatted, the process proceeds to STEP S2. On the other hand, if the format determining unit 40 determines that the inserted disc 59 is formatted, the process proceeds to STEP S7.

At STEP S2, the format determining unit 40 identifies the type of the inserted disc 59. If the disc 59 is identified to be a DVD+RW disc, the process proceeds to STEP S3. At STEP S3, a user is prompted to select the aspect ratio of movies to be recorded. At STEP S4, the CPU 31 determines whether or not the aspect ratio has been selected. More specifically, for example, the CPU 31 supplies the image signal corresponding to an aspect ratio setting screen 71 shown in FIG. 3 to the display unit 52 via the display control unit 36. The image of the aspect ratio setting screen 71 is displayed on the display unit 52. The aspect ratio setting screen 71 includes a button 72 for “16:9 wide” and a button 73 for “4:3”. The users can select the aspect ratio to be set for the disc 59, i.e., a DVD+RW disc, on this screen by selecting one of the buttons.

Instead of the aspect ratio setting screen 71 shown in FIG. 3, an aspect ratio setting screen 81 shown in FIG. 4 may be displayed. The aspect ratio setting screen 81 includes a button 82 for “16:9 wide” and a button 83 for “4:3”. The users can select the aspect ratio to be set for the disc 59, i.e., a DVD+RW disc, on this screen by selecting one of the buttons. The aspect ratio setting screen 81 further includes a button 84 for “decide later”. Selecting the button 84 allows the user to delay the selection of the aspect ratio.

At STEP S4, if the CPU 31 determines that the aspect ratio has been selected, the process proceeds to STEP S5. When the user has selected the button 84 for “decide later” on the aspect ratio setting screen 81, which is displayed at STEP S3, shown in FIG. 4, STEP S5 is skipped.

At STEP S5, the aspect ratio setting unit 41 notifies the disc interface 23 of the aspect ratio selected by the user. The disc interface 23 records the aspect ratio information in a predetermined area, which is prescribed by the +VR format, of the disc 59, i.e., a DVD+RW disc, on the basis of this notification.

At STEP S6, the format determining unit 40 instructs the disc interface 23 to initialize the disc 59 according to the +VR format. The disc interface 23 initializes the disc 59, i.e., a DVD+RW disc, according to the +VR format on the basis of this instruction.

The disc 59, i.e., a DVD+RW disc, having undergone the processing performed at STEP S6 has been formatted. At STEP S7, a process is performed on the formatted disc. The disc 59 can be removed from the disc interface 23 after the processing at STEP S6 is completed.

On the other hand, if the disc 59 is identified to be a DVD-RW disc at STEP S2, the process proceeds to STEP S8. At STEP S8, the user is prompted to select the format (i.e., the “VIDEO format” or the “−VR format”) of the disc 59, i.e., a DVD-RW disc. In response to the user's selection of the format, at STEP S9, the format determining unit 40 instructs the disc interface 23 to initialize the disc 59 according to the format selected by the user. The disc interface 23 initializes the disc 59, i.e., a DVD-RW disc, according to the VIDEO format or the −VR format on the basis of this instruction. The disc 59, i.e., a DVD-RW disc, having undergone the processing performed at STEP S9 has been formatted. Since the DVD-RW is free from the standardization of the aspect ratio of chapters to be recorded, the aspect ratio standardization process ends.

In addition, if the disc 59 is identified to be a DVD-R disc at STEP S2, the aspect ratio standardization process ends since a DVD-R disc is free from the initialization and the standardization of the aspect ratio of chapters to be recorded.

Referring to a flowchart shown in FIG. 5, a process performed on the formatted disc at STEP S7 will be described. As is obvious from the above description, the process for the formatted disc is performed only on the disc 59 that is a DVD+RW disc. Hereinafter, the disc 59 that is a DVD+RW disc is also referred to as a “DVD+RW disc” 59.

At STEP S21, the aspect ratio setting unit 41 determines whether or not the aspect ratio is set for the inserted DVD+RW disc 59 (i.e., whether or not the aspect ratio information is recorded in the predetermined area prescribed in the +VR format). If the aspect ratio setting unit 41 determines that the aspect ratio is set for the DVD+RW disc 59, the process proceeds to STEP S22. At STEP S22, the aspect ratio setting unit 41 controls the disc interface 23 to read out the aspect ratio information recorded in the predetermined area of the DVD+RW disc 59, and the process proceeds to STEP S25.

On the other hand, if the aspect ratio setting unit 41 determines that the aspect ratio is not set for the inserted DVD+RW disc 59, the process proceeds to STEP S23. At STEP S23, the user is prompted to select the aspect ratio of movies to be recorded as in the case of STEP S3. In response to the user's selection of the aspect ratio, at STEP S24, the aspect ratio setting unit 41 notifies the disc interface 23 of the aspect ratio selected by the user. The disc interface 23 records the aspect ratio information in a predetermined area, which is prescribed by the +VR format, of the DVD+RW disc 59 on the basis of this notification. The process then proceeds to STEP S25.

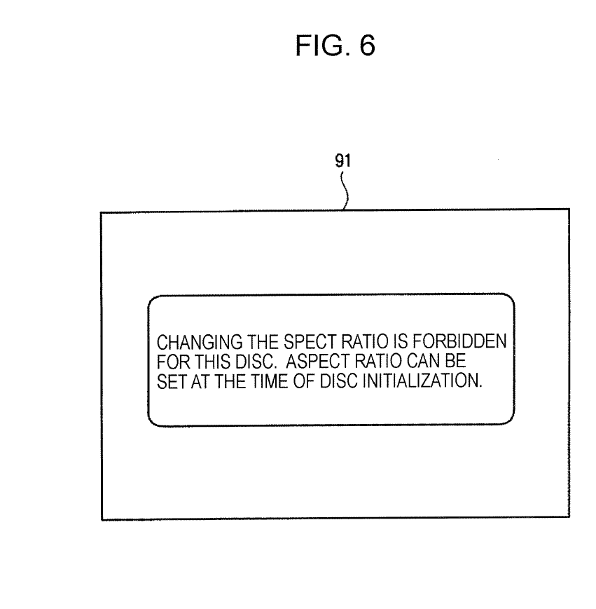

At STEP S25, the aspect ratio setting unit 41 sets each unit of the digital video camera 1 so as to be compatible with the aspect ratio recorded (or having been recorded) on the DVD+RW disc 59. At STEP S26, the aspect ratio setting unit 41 forbids changing of the aspect ratio set for the currently inserted DVD+RW disc 59. More specifically, for example, when the user operates a predetermined key or performs an operation on a predetermined setting screen to instruct changing of the aspect ratio, the aspect ratio setting unit 41 causes the display unit 52 to display a caution screen 91 shown in FIG. 6 so as to notify the user that changing of the aspect ratio is forbidden. Instead of displaying the caution screen 91, or while displaying the caution screen 91, an audio guidance may be provided. After performing these steps, the process for the formatted disc ends.

The above-described aspect ratio standardization process (including the process performed on the formatted disc) allows the aspect ratio of each chapter of the video images recorded on the DVD+RW disc 59 to be standardized to the aspect ratio selected at the time of formatting (at STEP S3) or that selected at the time of recording of a first chapter (at STEP S23), when the DVD+RW disc 59 is inserted. Accordingly, the compatibility of the DVD+RW disc 59 is guaranteed, and the images is reconstructed accurately at the aspect ratio even if the DVD+RW disc 59 is played back with apparatuses other than the digital video camera 1.

The embodiment of the present invention can be applied not only to video cameras but also video recorders that initialize DVD+RW discs according to the +VR format and use them.

In this specification, the steps executed according to a program include processing that is executed sequentially in the described order, and also includes processing that is executed in parallel or individually, not necessarily sequentially.

Additionally, a single computer may process the program, or distributed processing may be executed on the program by using a plurality of computers. Furthermore, the program may be transferred to a remote computer and be executed.

Moreover, the embodiments of the present invention should not be limited to the above described embodiments, and various modifications can be made without departing from the spirit and scope of the present invention.

What is claimed is:

1. An image data recording apparatus that sets only a single video image aspect ratio for a recording medium according to a predetermined recording format, the image data recording apparatus comprising:
determining means for determining whether or not the aspect ratio has been set for the recording medium;
selecting means for allowing, when the determining means determines that the aspect ratio has not been set for the recording medium, a user to select the aspect ratio to be set for the recording medium;
writing means for writing information denoting the selected aspect ratio in a predetermined area, which is prescribed in the predetermined recording format, of the recording medium;
reading means for reading out, when the determining means determines that the aspect ratio has been set for the recording medium, the information denoting the aspect ratio set for the recording medium;
setting means for setting each unit of the image data recording apparatus according to one of the aspect ratio denoted by the information written in the predetermined area of the recording medium and the aspect ratio denoted by the read out information; and
forbidding means for forbidding changing of the aspect ratio set in each unit of the image data recording apparatus.

2. The apparatus according to claim 1, further comprising:
image capturing means for capturing video images and generating corresponding image data.

3. The apparatus according to claim 1, wherein the selecting means is a graphical user interface that employs an operation screen.

4. The apparatus according to claim 1, wherein the recording medium is removable.

5. The apparatus according to claim 1, wherein the recording medium is a DVD+RW (Digital Versatile Disc+ReWritable) disc, and wherein the predetermined recording format is a DVD+VR (Video Recording) format.

6. An image data recording method for an image data recording apparatus that sets only a single video image aspect ratio for a recording medium according to a predetermined recording format, the image data recording method comprising the steps of:
determining whether or not the aspect ratio has been set for the recording medium;
allowing, when the aspect ratio is determined not to have been set for the recording medium, a user to select the aspect ratio to be set for the recording medium;
writing information denoting the selected aspect ratio in a predetermined area, which is prescribed in the predetermined recording format, of the recording medium;
reading out, when the aspect ratio is determined to have been set for the recording medium, the information denoting the aspect ratio set for the recording medium;
setting each unit of the image data recording apparatus according to one of the aspect ratio denoted by the information written in the predetermined area of the recording medium and the aspect ratio denoted by the read out information; and
forbidding changing of the aspect ratio set in each unit of the image data recording apparatus.

7. A program for controlling an image data recording apparatus that sets only a single video image aspect ratio for a recording medium according to a predetermined recording format, the program causing a computer to execute a process, the process comprising the steps of:
determining whether or not the aspect ratio has been set for the recording medium;
allowing, when the aspect ratio is determined not to have been set for the recording medium, a user to select the aspect ratio to be set for the recording medium;
writing information denoting the selected aspect ratio in a predetermined area, which is prescribed in the predetermined recording format, of the recording medium;
reading out, when the aspect ratio is determined to have been set for the recording medium, the information denoting the aspect ratio set for the recording medium;
setting each unit of the image data recording apparatus according to one of the aspect ratio denoted by the information written in the predetermined area of the recording medium and the aspect ratio denoted by the read out information; and
forbidding changing of the aspect ratio set in each unit of the image data recording apparatus.

8. An image data recording apparatus that sets only a single video image aspect ratio for a recording medium according to a predetermined recording format, the image data recording apparatus comprising:
selecting means for allowing, when the recording medium has not been initialized, a user to select the aspect ratio to be set for the recording medium;
writing means for writing information denoting the selected aspect ratio in a predetermined area, which is prescribed in the predetermined recording format, of the recording medium and for initializing the recording medium;
setting means for setting each unit of the image data recording apparatus according to the aspect ratio denoted by the information written in the predetermined area of the recording medium; and
forbidding means for forbidding changing of the aspect ratio set in each unit of the image data recording apparatus.

9. An image data recording method for an image data recording apparatus that sets only a single video image aspect ratio for a recording medium according to a predetermined recording format, the image data recording method comprising steps of:
allowing, when the recording medium has not been initialized, a user to select the aspect ratio to be set for the recording medium;
writing information denoting the selected aspect ratio in a predetermined area, which is prescribed in the predetermined recording format, of the recording medium and initializing the recording medium;
setting each unit of the image data recording apparatus according to the aspect ratio denoted by the information written in the predetermined area of the recording medium; and
forbidding changing of the aspect ratio set in each unit of the image data recording apparatus.

10. A program for controlling an image data recording apparatus that sets only a single video image aspect ratio for a recording medium according to a predetermined recording format, the program causing a computer to execute a process, the process comprising the steps of:
allowing, when the recording medium has not been initialized, a user to select the aspect ratio to be set for the recording medium;
writing information denoting the selected aspect ratio in a predetermined area, which is prescribed in the predetermined recording format, of the recording medium and initializing the recording medium;
setting each unit of the image data recording apparatus according to the aspect ratio denoted by the information written in the predetermined area of the recording medium; and
forbidding changing of the aspect ratio set in each unit of the image data recording apparatus.

11. An image data recording apparatus that sets only a single video image aspect ratio for a recording medium according to a predetermined recording format, the image data recording apparatus comprising:
reading means for reading out information denoting the aspect ratio set for the recording medium;
setting means for setting each unit of the image data recording apparatus according to the aspect ratio denoted by the read out information; and
forbidding means for forbidding changing of the aspect ratio set in each unit of the image data recording apparatus.

12. An image data recording method for an image data recording apparatus that sets only a single video image aspect ratio for a recording medium according to a predetermined recording format, the image data recording method comprising the steps of:
reading out information denoting the aspect ratio set for the recording medium;
setting each unit of the image data recording apparatus according to the aspect ratio denoted by the read out information; and
forbidding changing of the aspect ratio set in each unit of the image data recording apparatus.

13. A program for controlling an image data recording apparatus that sets only a single video image aspect ratio for a recording medium according to a predetermined recording format, the program causing a computer to execute a process, the process comprising the steps of:
reading out information denoting the aspect ratio set for the recording medium;
setting each unit of the image data recording apparatus according to the aspect ratio denoted by the read out information; and
forbidding changing of the aspect ratio set in each unit of the image data recording apparatus.

14. An image data recording apparatus that sets only a single video image aspect ratio for a recording medium according to a predetermined recording format, the image data recording apparatus comprising:
a determining unit for determining whether or not the aspect ratio has been set for the recording medium;
a selecting unit for allowing, when the determining unit determines that the aspect ratio has not been set for the recording medium, a user to select the aspect ratio to be set for the recording medium;
a writing unit for writing information denoting the selected aspect ratio in a predetermined area, which is prescribed in the predetermined recording format, of the recording medium;
a reading unit for reading out, when the determining unit determines that the aspect ratio has been set for the recording medium, the information denoting the aspect ratio set for the recording medium;
a setting unit for setting each unit of the image data recording apparatus according to one of the aspect ratio denoted by the information written in the predetermined area of the recording medium and the aspect ratio denoted by the read out information; and
a forbidding unit for forbidding changing of the aspect ratio set in each unit of the image data recording apparatus.

15. An image data recording apparatus that sets only a single video image aspect ratio for a recording medium according to a predetermined recording format, the image data recording apparatus comprising:
a selecting unit for allowing, when the recording medium has not been initialized, a user to select the aspect ratio to be set for the recording medium;
a writing unit for writing information denoting the selected aspect ratio in a predetermined area, which is prescribed in the predetermined recording format, of the recording medium and for initializing the recording medium;
a setting unit for setting each unit of the image data recording apparatus according to the aspect ratio denoted by the information written in the predetermined area of the recording medium; and
a forbidding unit for forbidding changing of the aspect ratio set in each unit of the image data recording apparatus.

16. An image data recording apparatus that sets only a single video image aspect ratio for a recording medium according to a predetermined recording format, the image data recording apparatus comprising:
a reading unit for reading out information denoting the aspect ratio set for the recording medium;
a setting unit for setting each unit of the image data recording apparatus according to the aspect ratio denoted by the read out information; and
a forbidding unit for forbidding changing of the aspect ratio set in each unit of the image data recording apparatus.
